(19) United States
(12) Patent Application Publication
(10) Pub. No.: US 2026/0241914 A1
(43) Pub. Date: Aug. 20, 2026

(54) Method for Generating a Brake Signal for Electric Braking of at Least Partially Electrically Powered Motor Vehicle, Computer Program Product, Computer-Readable Storage Medium, and Electronic Computing Devices

(71) Applicant: Bayerische Motoren Werke Aktiengesellschaft, Muenchen (DE)

(72) Inventors: Christian FLENKER, Baldham (DE); Klaus HABERMANN, Muenchen (DE); Markus KOBAN, Ilmmuenster (DE); Yoann MARAIS, Muenchen (DE)

(21) Appl. No.: 19/539,177

(22) Filed: Feb. 13, 2026

(30) Foreign Application Priority Data
Feb. 14, 2025 (DE) 10 2025 105 642.0

(51) Int. Cl. B60W 10/184; B60T 8/175; B60T 13/58; B60W 10/10

(52) U.S. Cl. CPC B60W 10/184; B60T 8/175; B60T 13/586; B60W 10/10

(57) ABSTRACT

A method for generating a brake signal for electric braking of an at least partially electrically powered motor vehicle by an electronic computing device of a braking apparatus of the motor vehicle includes determining a stopping phase of the motor vehicle by the electronic computing device, wherein the stopping phase is defined from a predetermined speed value to the standstill of the motor vehicle, and generating a control torque curve for the brake signal such that a polynomial torque curve related to a vehicle speed is generated for an electric drive motor of the motor vehicle as an electric braking device of the braking apparatus for electric braking. A computer program product, a non-transitory computer-readable storage medium, and an electronic computing device are also provided.

### CROSS REFERENCE TO RELATED APPLICATION

This application claims priority under 35 U.S.C. §119 from German Patent Application No. DE 10 2025 105 642.0, filed February 14, 2025, the entire disclosure of which is herein expressly incorporated by reference.

### BACKGROUND AND SUMMARY

The following invention relates to a method for generating a brake signal for electric braking of a motor vehicle that is at least partially electrically powered by means of an electronic computing device of a braking apparatus of the motor vehicle in accordance with the patent claims. Furthermore, the invention relates to a corresponding computer program product, a corresponding computer-readable storage medium, and a corresponding electronic computing device.

It is already known from the prior art that, for example, in at least partially electrically powered motor vehicles or in fully electrically powered vehicles, the electric drive motor can be used to brake the motor vehicle. In particular, the electric motor is then in what is known as generator mode and can also obtain electrical energy through recuperation by braking. This is particularly desirable because, for example, it can increase the range of the at least partially electrically powered motor vehicle.

Furthermore, corresponding friction brakes are known, which cause braking based on friction on, for example, the wheels themselves. Friction braking can lead to corresponding brake particles, which are undesirable. Furthermore, the energy is converted into frictional heat and cannot be used, for example, to increase the range.

It is therefore desirable to brake the motor vehicle, which is substantially at least partially electrically powered, as much as possible with the electric brake in order to recover energy and at the same time reduce environmental pollution caused by corresponding particles.

It is also already known from the prior art that, for example, at higher speeds, for example above 6 km/h, a driver's braking request is implemented not by the friction brake but by the electric motor (brake energy recovery). When approaching a standstill, however, the brake pedal request can be implemented with the friction brake. It is also known that, for example, the stopping request from the accelerator pedal is continuously implemented via the electric motor and the motor vehicle recovers energy until it comes to a standstill. It is also known that, in addition to recuperation to a standstill from the accelerator pedal request, the brake request is also implemented from the brake pedal with the friction brake until the motor vehicle stops via the friction brake. The brake pedal can also be pressed to stop, as otherwise the electric motor would cause the motor vehicle to creep or start moving. The request from the brake pedal is implemented with the friction brake and clamps the motor vehicle, which can also be referred to as clamped stopping, thus generating creeping against the friction brake. This can also cause brake particles, creaking noises, and small jerks due to the brakes sticking. When at a standstill, the friction brake holds. The same principle applies to at least partially automated functions.

Furthermore, it is known that even when the vehicle is close to a standstill, the electric motor carries out the deceleration request so that the friction brake is not used, which can also be referred to as recuperation to a standstill or as a stop controller. When stationary, the vehicle is held by the electric motor. During an electric stopping process, the torque requested by the driver, such as delayed torque via the accelerator/brake pedal, is blended into the holding torque, which can be referred to as driving resistance. This blending takes place with a linear blending factor between a start speed dependent on the desired deceleration and a standstill.

From this blended torque, a target speed or trajectory can be calculated, which the vehicle ideally follows to a standstill without external disturbances and tolerances. To compensate for real disturbances, a speed controller is activated which controls deviations of the actual speed of the vehicle along this target speed, thus bringing the motor vehicle to a standstill and then holding it there.

DE 10 2019 103 375 A1 describes a control unit for a motor vehicle that comprises at least one electric motor for driving one or more wheels of the vehicle and at least one friction brake. The control unit is set up to determine that a one-pedal feeling function is to be provided via an accelerator pedal of the vehicle and/or a creep function is to be provided via a brake pedal of the vehicle. Furthermore, the control unit is configured to operate the electric motor and the friction brake in combination at least temporarily in order to provide the one-pedal feeling function and/or the creep function.

DE 10 2022 125 558 A1 relates to a method for braking an electrically driven vehicle, in which an individual current desired braking torque is detected in a driving situation, which is sufficient to decelerate the vehicle to a standstill, and the vehicle is braked to a standstill exclusively with an electric drive motor of the vehicle. An output torque is calculated, which incorporates the current desired braking torque, and in a speed transition range between a starting speed and the standstill of the vehicle, a control torque curve is calculated which, starting from the output torque, leads continuously to 0 (or a holding torque on inclines/declines). The deceleration torque is generated by the electric drive motor in accordance with the control torque curve.

An object of the present invention is to provide a method, a computer program product, a non-transitory computer-readable storage medium, and an electronic computing device by means of which improved electric braking of at least partially electrically powered motor vehicles can be achieved.

This object is achieved by a method, a corresponding computer program product, a corresponding non-transitory computer-readable storage medium, and a corresponding electronic computing device according to the independent claims. Advantageous embodiments are specified in the dependent claims.

One aspect of the invention relates to a method for generating a brake signal for electric braking of an at least partially electrically powered motor vehicle by means of an electronic computing device of a braking apparatus of the motor vehicle. A stopping phase of the motor vehicle is determined by means of the electronic computing device, wherein the stopping phase is defined from a predetermined speed value to the standstill of the motor vehicle. The control torque curve is generated in such a way that a polynomial torque curve related to the vehicle speed is generated for an electric drive motor of the motor vehicle as an electric braking device of the braking apparatus for electric braking.

In other words, the plan is to apply a polynomial torque rather than a linear torque based on vehicle speed, as is the case with the prior art. In other words, a polynomial transition factor is generated instead of a linear transition factor. According to the prior art, the linear transition means that the time derivative of the torque is no longer continuous at the start of the transition (kink in the torque curve). The driver feels this as a jolt.

According to the invention, it is now envisaged that the transition factor is modified in such a way that no discontinuities arise in the temporal derivative of the torque curve and a standstill is reached early, which is achieved by the polynomial. This causes the torque to be blended more quickly, which means that the driver of the motor vehicle feels a small but very comfortable jolt as confirmation of stopping, confirming that a standstill has been reached. Likewise, no deceleration is noticeable.

The invention has the advantage that the range can also be improved accordingly, as no energy is lost through the friction brake. Furthermore, there is a reduction in brake particle emissions in the near-standstill range. There is also an increase in comfort in standard road situations, as there is no oscillation or brake squeal. Furthermore, safe and comfortable stopping and holding at a standstill is still possible.

In particular, the invention enables precise and efficient deceleration through the polynomial torque curve, which has a corresponding effect on the electric motor. This allows for smoother stops compared to conventional mechanical brakes. Regenerative braking also allows kinetic energy to be captured during deceleration and converted into electrical energy, which in turn can be stored in the electrical energy storage device. This reduces energy consumption and extends the range of the motor vehicle. The electronic computing device, which can also be referred to as an electronic control unit (ECU), calculates the stopping phase based on a predetermined speed value and uses this information to generate the brake signal. This enables adaptive braking behavior depending on the driving situation. The polynomial torque over speed enables a smooth and controlled transition from deceleration to the stopping phase.

It has also proven advantageous to generate the brake signal in such a way that a stopping jerk is generated in the motor vehicle when it comes to a standstill. This prevents what is known as "rollback." When a motor vehicle comes to a standstill on an incline, gravity can cause it to roll backward slightly, which is referred to as "rollback." By generating a slight jolt or stopping jolt at the moment of standstill, the system can counteract this rollback and maintain a stable position. Furthermore, the function of the jolt is helpful when the motor vehicle is brought to a stop on an incline, as it reduces the risk of uncontrolled movements and potential accidents. The slight jolt can also give the driver a stronger feeling that the motor vehicle has actually come to a stop.

It has also proven advantageous to take into account the incline of the surface on which the vehicle is positioned when generating the brake signal. This is particularly important because, on a level surface, for example, the electric motor must apply a braking torque of zero in order to prevent the vehicle from rolling either forwards or backwards. On a sloping surface, on the other hand, a corresponding negative torque, i.e., a backward torque, must be applied to prevent the vehicle from moving. On an ascending surface, on the other hand, a forward torque must be applied. Taking the surface into account, for example, based on sensors or navigation data, ensures that the correct torque can always be generated. In particular, the electronic computing device takes into account the gradient, for example, of the road on which the motor vehicle is traveling. By taking the gradient into account, the electronic computing device can adjust the braking force accordingly. On an incline, the motor vehicle or electric motor may require slightly less braking force, as gravity assists the deceleration. On a downhill slope, on the other hand, more braking force is required to counteract gravity and prevent unwanted rolling. This precise control over the braking force increases safety by preventing uncontrolled acceleration or excessive braking, which could lead to instability. It also improves energy efficiency by optimizing the amount of braking required depending on the terrain.

Another advantage is that a higher-order polynomial can be used as the polynomial torque curve. In particular, the higher-order polynomial can be used instead of the linear torque according to the prior art. A higher-order polynomial allows detailed control over the deceleration curve. This results in smoother transitions and gradual deceleration, which improves driving comfort. A higher-order polynomial can enable faster and more precise adjustment of braking force to real-time changes in vehicle speed and road conditions. By incorporating a higher degree, the system can model complex driving scenarios more accurately. This opens the door to advanced features such as predictive braking and correspondingly adaptable control systems. In particular, at least a second-degree or third-degree polynomial can be used accordingly.

A preferred embodiment provides for the use of a fifth-degree polynomial. This allows for precise control over the braking force. A fifth-degree polynomial can generate a significantly more complex and nuanced curve than lower-order polynomials. This enables very sensitive adjustments to the braking force, resulting in smoother transitions and possibly even anticipatory braking. Fifth-degree polynomials have the ability to model complex vehicle dynamics and road conditions more accurately. This can be particularly advantageous in situations that require rapid changes in braking force or when driving on rough terrain.

It has also proven advantageous to additionally adapt a controller parameter of a speed controller of the braking apparatus during the stopping phase. In particular, the controller parameters of the speed controller can also be calculated in parallel with the blend factor so that they control the target speed during the stopping phase but do not cause excessive and rapid torque changes, resulting in comfortable vehicle movement. As the vehicle approaches a standstill, these controller parameters become increasingly larger in order to provide maximum controller stiffness at a standstill, so that very rapid corrections result in minimal speed deviations that safely control the standstill.

It has also proven advantageous to generate the polynomial torque curve as a function of the type of motor vehicle. This allows the electric brake signal to be adjusted depending on the derivative. This allows the stop confirmation to be performed according to the vehicle characteristics. Sports cars, for example, can perform a faster torque crossover, while family cars perform a slow crossover. This allows a crossover factor to be implemented that is tailored to the driver. The driver's driving behavior can also be evaluated or observed over a historical period of time and the crossover factor can be adjusted accordingly on this basis. If, for example, the driver is identified as a sportier driver, a faster torque crossover can be implemented than if the driver is identified as a family driver, which allows for a slower crossover.

The method presented is a computer-implemented method. Therefore, a further aspect of the invention relates to a computer program product with program code means which cause an electronic computing device, when the program code means are processed by the electronic computing device, to perform a method according to the preceding aspect.

The invention also relates to a computer-readable storage medium with at least the computer program product according to the preceding aspect.

Yet another aspect of the invention relates to an electronic computing device of a braking apparatus of an at least partially electrically powered motor vehicle for generating a brake signal for electric braking, wherein the electronic computing device is designed to perform a method according to the preceding aspect. In particular, the method is performed by means of the electronic computing device.

The invention also relates to a braking apparatus with at least the electronic computing device and with a first braking device, which is designed as an electric drive motor. The braking apparatus may also have a second braking device, for example, in the form of a friction brake.

Furthermore, the invention also relates to a motor vehicle that is at least partially electrically powered and has at least the braking apparatus according to the preceding aspect. The motor vehicle may also be fully electric.

Advantageous embodiments of the method are to be regarded as advantageous embodiments of the computer program product, the computer-readable storage medium, the electronic computing device, the braking apparatus, and the motor vehicle. The electronic computing device, the braking apparatus, and the motor vehicle have specific features for this purpose in order to be able to carry out the corresponding method steps.

In the present disclosure, a computing unit/electronic computing device can be understood, for example, as a data processing device with processing circuits. A computing unit can therefore perform computing operations to process data. The computing operations may also include indexed accesses to a data structure, for example a look-up table (LUT).

A computing unit may comprise one or more computers, one or more microcontrollers, and/or one or more integrated circuits, for example, one or more application-specific integrated circuits (ASICs), one or more field-programmable gate arrays (FPGAs), and/or one or more systems on a chip (SoCs). The computing unit may also include one or more processors, for example, one or more microprocessors, one or more central processing units (CPUs), one or more graphics processing units (GPUs), and/or one or more signal processors, in particular one or more digital signal processors (DSPs). The computing unit may also comprise a physical or virtual cluster of computers or other units mentioned above.

A computing unit may also include one or more hardware and/or software interfaces and/or one or more memory units. A memory unit may be embodied as volatile data storage, for example a dynamic random access memory (DRAM) or static random access memory (SRAM), or as non-volatile data storage, for example as a read-only memory (ROM), programmable read-only memory (PROM), erasable programmable read-only memory (EPROM), or electrically erasable programmable read-only memory (EEPROM), a flash memory or flash EEPROM, a ferromagnetic random access memory (FRAM), a magnetoresistive random access memory, (MRAM), or a phase-change random access memory (PCRAM).

Further features of the invention can be found in the claims, the figures, and the description of the figures. The features and combinations of features mentioned above in the description, as well as the features and combinations of features mentioned below in the description of the figures and/or shown in the figures alone, are not only usable in the combination specified in each case, but also in other combinations or on their own.

The invention will now be explained in more detail with reference to a preferred exemplary embodiment and with reference to the drawings.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic side view of an embodiment of a motor vehicle with an embodiment of a braking apparatus with an embodiment of an electronic computing device;

FIG. 2 shows three schematic diagrams according to one embodiment of the method; and

FIG. 3 shows a further schematic diagram for carrying out the method.

### DETAILED DESCRIPTION OF THE DRAWINGS

In the figures, identical or functionally identical elements are designated by the same reference signs.

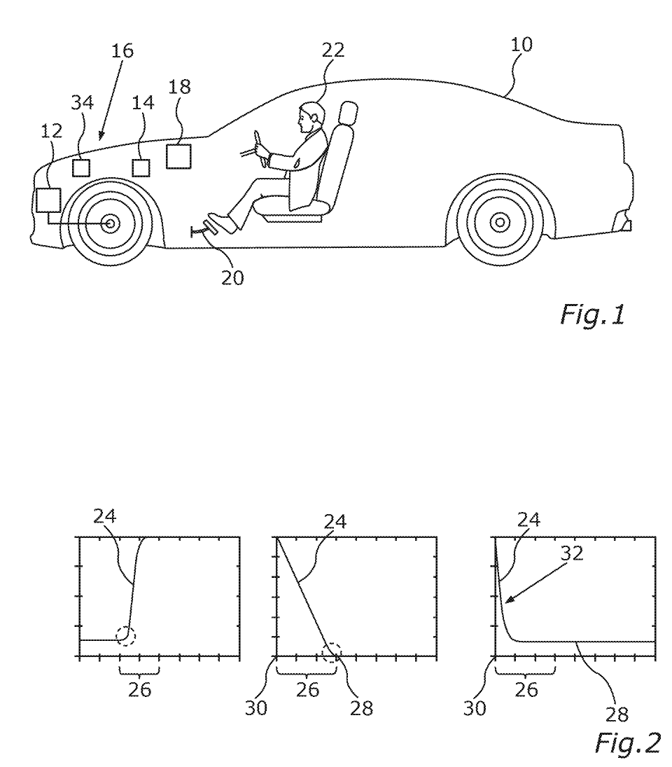

FIG. 1 shows a schematic side view of an embodiment of a motor vehicle 10. The motor vehicle 10 is at least partially electrically powered or fully electrically powered. For this purpose, the motor vehicle 10 has an electric drive motor 12. The electric drive motor 12 can be designed to move the motor vehicle 10. However, it is also possible that, for example, in a corresponding generator mode or in a recuperation mode of the electric drive motor 12, it can also be used for electric braking of the motor vehicle 10. Alternatively, a purely electric motor can also be provided, which is designed only for braking and recuperation. This has the particular advantages that, for example, electrical energy can be recovered, thereby extending the range of the motor vehicle 10. Furthermore, corresponding brake particles, which would arise, for example, during friction braking with a friction brake 14, can be prevented.

The motor vehicle 10 has a braking apparatus 16. As already mentioned, the braking apparatus 16 is designed to brake the motor vehicle 10. In particular, at least during the braking process, the braking apparatus 16 can then be assigned at least the electric drive motor 12 as a first braking device. Furthermore, the friction brake 14 can also be assigned to the braking apparatus 16. In addition, the braking apparatus 16 also has an electronic computing device 18. Furthermore, a brake detection device 20 is shown, which may correspond, for example, to a brake pedal. In particular, at least the braking request of a driver 22 of the motor vehicle 10 can be detected via the brake detection device 20. In particular, the brake detection device 20 can also be provided accordingly in the embodiment as a one-pedal braking device.

FIG. 2 shows three schematic diagrams for the method according to the invention. The left-hand side shows a braking torque over time, the middle diagram describes the speed over time, and the right-hand diagram describes the torque over speed. The left-hand side, which describes the torque over time, shows a continuous curve of a corresponding brake signal 24 as well as a rapid fade and no corresponding release of the brakes. Furthermore, the middle part of FIG. 2 shows that the standstill can be quickly adjusted. The right part of the figure also shows that a polynomial torque curve 32 can be generated by means of the brake signal 24.

According to one embodiment of the method, it is provided that the brake signal 24 for the electric braking of the motor vehicle 10 can be generated by means of the electronic computing device 18. A stopping phase 26 of the motor vehicle 10 is determined by means of the electronic computing device 18, wherein the stopping phase 26 is defined from a predetermined speed value 28 to the standstill 30 of the motor vehicle 10. The brake signal 24 is generated in such a way that the polynomial torque curve 32 for the electric drive motor 12 of the motor vehicle 10 is generated as an electric braking device of the braking apparatus 16 for electric braking.

In particular, the brake signal 24 is generated in such a way that, when the motor vehicle 10 comes to a standstill 30, a stopping jolt is generated in the motor vehicle 10.

Furthermore, it may be provided that an incline of a surface on which the motor vehicle 10 is positioned is taken into account when generating the brake signal 24.

It may also be provided that a polynomial of higher degree is used as the polynomial torque curve 32. In particular, a fifth-degree polynomial may be used.

Furthermore, it may also be provided that a controller parameter of a speed controller 34 (FIG. 1) of the braking apparatus 16 is additionally adapted during the stopping phase 26.

Furthermore, it may also be provided that the polynomial torque curve 32 is additionally generated as a function of a type of motor vehicle 10.

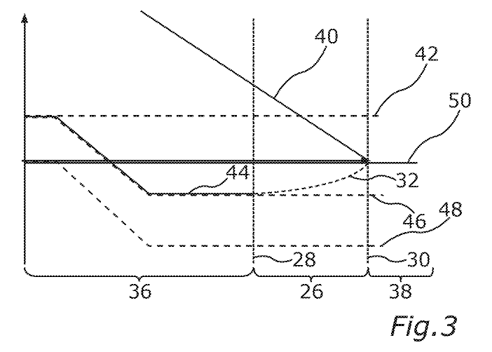

FIG. 3 again shows a time diagram according to one embodiment of the method. Three phases are shown. First, a first phase 36, which again shows braking at higher speeds. Furthermore, a second phase is shown, which corresponds to the stopping phase 26. Furthermore, a third phase 38 is then shown, which corresponds to the holding phase, i.e., the standstill 30.

FIG. 3 shows a vehicle speed 40, a driver request on the accelerator pedal 42 in Newton meters, a drive torque 44 of the electric drive motor 12 in Newton meters, which in particular transitions into the polynomial torque curve 32 in the stopping phase 26, a resulting total torque request 46 in Newton meters, and a driver brake request from the brake pedal 48 in Newton meters. For informational purposes only, a friction brake torque 50 generated by the friction brake 14 is also shown, which in this exemplary embodiment is zero because electric braking is preferred.

Overall, the figures show that the so-called crossover factor is modified so that there is no torque continuity and the standstill is reached earlier, which is achieved by the polynomial torque curve. This causes the torque to transition more quickly, resulting in the driver feeling a small but very comfortable jolt that confirms that a standstill has been reached. There is also no noticeable deceleration. Furthermore, this stopping confirmation can be tailored to the character of the vehicle; for example, in sports cars 10, a fast torque transition can take place, while in a family car, a slow transition takes place.

At the same time, the controller parameters are determined depending on this transition factor so that they control the target speed during the stopping phase 26 but do not cause too large and rapid a change in torque, resulting in comfortable vehicle movement. As the vehicle approaches a standstill 30, these become larger and larger in order to provide maximum controller stiffness at a standstill 30.

For example, the driver 22 is driving on level ground in what is known as driving mode D and wants to stop by pressing the brake pedal. The desired deceleration is implemented using the logic and torque curve described above. The standstill 30 is achieved silently, without brake squeal, and without stopping jerk, in particular without oscillation of the entire body, by the method according to the invention. The motor vehicle 10 is not unbraked and the standstill 30 is achieved quickly and safely. A comfortable haptic stop confirmation, but without oscillation, is created, which confirms that the standstill 30 has been reached.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### List of reference signs

10 motor vehicle

12 electric drive motor

14 friction brake

16 braking apparatus

18 electronic computing device

20 brake detection device

22 driver

24 brake signal

26 stopping phase

28 specified speed value

30 standstill

32 polynomial torque curve

34 speed control

36 first phase

38 third phase

40 vehicle speed

42 driver request on the accelerator pedal

44 drive torque

46 resulting total torque request

48 driver brake demand on brake pedal

50 friction braking torque

What is claimed is:

1. A method for generating a brake signal for electrically braking an at least partially electrically powered motor vehicle by an electronic computing device of a braking apparatus of the motor vehicle, the method comprising:
determining a stopping phase of the motor vehicle by the electronic computing device, wherein the stopping phase is defined from a predetermined speed value to a standstill of the motor vehicle; and
generating a control torque curve for the brake signal such that a polynomial torque curve related to a vehicle speed is generated for an electric drive motor of the motor vehicle as an electric braking device of the braking apparatus for electric braking.

2. The method according to claim 1, wherein the brake signal is generated in such a way that, when the motor vehicle comes to a standstill, a stopping jerk is generated in the motor vehicle.

3. The method according to claim 1, wherein a gradient of the a surface on which the motor vehicle is positioned is taken into account when generating the brake signal.

4. The method according to claim 2, wherein a gradient of the a surface on which the motor vehicle is positioned is taken into account when generating the brake signal.

5. The method according to claim 1, wherein at least a second-degree polynomial is used for the polynomial torque curve.

6. The method according to claim 2, wherein at least a second-degree polynomial is used for the polynomial torque curve.

7. The method according to claim 3, wherein at least a second-degree polynomial is used for the polynomial torque curve.

8. The method according to claim 5, wherein a fifth-degree polynomial is used for the polynomial torque curve.

9. The method according to claim 6, wherein a fifth-degree polynomial is used for the polynomial torque curve.

10. The method according to claim 7, wherein a fifth-degree polynomial is used for the polynomial torque curve.

11. The method according to claim 1, wherein a controller parameter of a speed controller of the braking apparatus is adapted during the stopping phase.

12. The method according to claim 2, wherein a controller parameter of a speed controller of the braking apparatus is adapted during the stopping phase.

13. The method according to claim 3, wherein a controller parameter of a speed controller of the braking apparatus is adapted during the stopping phase.

14. The method according to claim 1, wherein the polynomial torque curve is generated depending on a type of the motor vehicle.

15. The method according to claim 2, wherein the polynomial torque curve is generated depending on a type of the motor vehicle.

16. The method according to claim 3, wherein the polynomial torque curve is generated depending on a type of the motor vehicle.

17. A computer program product including a program code which causes an electronic computing device to perform a method according to claim 1 when the program code is processed by the electronic computing device.

18. A non-transitory computer-readable storage medium with at least one computer program product according to claim 17.

19. An electronic computing device of a braking apparatus of an at least partially electrically powered motor vehicle for generating a brake signal for electric braking, wherein the electronic computing device is configured to carry out a method according to claim 1.
